(19) United States
(12) Patent Application Publication
(10) Pub. No.: US 2013/0006865 A1
(43) Pub. Date: Jan. 3, 2013

(54) SYSTEMS, METHODS, APPARATUSES, AND COMPUTER PROGRAM PRODUCTS FOR PROVIDING NETWORK-ACCESSIBLE PATIENT HEALTH RECORDS

(75) Inventor: Rick Spates, Canton, GA (US)

(73) Assignee: McKesson Financial Holdings Limited

(21) Appl. No.: 13/172,340

(22) Filed: Jun. 29, 2011

(51) Int. Cl. G06Q 50/00; H04L 9/14

(52) U.S. Cl. 705/50

(57) ABSTRACT

Methods, apparatuses, and computer program products are provided for providing network-accessible patient health records. A method may include generating a patient health record document. The method may further include obtaining a set of one or more symmetric keys from a health record trust entity. The method may additionally include encrypting at least a portion of the patient health record document with the obtained set of symmetric keys. The method may also include causing the encrypted patient health record document to be published to a location on a network. The published encrypted patient health record document may have a resource identifier enabling the published encrypted patient health record document to be accessed over the network. Corresponding systems, apparatuses and computer program products are also provided.

### TECHNOLOGICAL FIELD

Embodiments of the present invention relate generally to computing technology and, more particularly, relate to methods, apparatuses, and computer program products for providing network-accessible patient health records.

### BACKGROUND

The health care industry is currently experiencing a sea change in the practice of maintaining health records. In this regard, the evolution of modern computing and networking technology has lead to a widespread adoption and increasing reliance on computers and associated software for facilitating patient treatment, maintaining patient treatment records, and for tracking and payment of charges attendant to patient treatment. For example, use of computing technology by health service providers has allowed for the creation and maintenance of electronic health record documents for patients, including medical treatment and diagnosis records, billing records, insurer explanation of benefits records, and payment records. Electronic maintenance of such records has offered several advantages to health service providers, including more ready access to patient health information and a reduction in reliance on cumbersome paper files, which may be burdensome to maintain and may be more susceptible to data loss than electronic systems.

While there has been a rapidly increasing reliance on electronic health records, the implementation of computer systems supporting electronic patient health records has largely been siloed within the confines of individual service providers. In this regard, to date there has not been a system allowing for secure exchange of electronic health records among service providers, including healthcare providers, insurers, and the like. Instead, adoption of electronic health records has largely been in the form of numerous proprietary systems internal to various providers, often having their own proprietary data formats, which have made exchange of information between providers difficult, and which have provided patients with little control over the privacy of their records.

### BRIEF SUMMARY OF SOME EXAMPLES OF THE INVENTION

Systems, methods, apparatuses, and computer program products are herein provided for providing network-accessible patient health records. These systems, methods, apparatuses, and computer program products may provide several advantages to patients, health service providers, computers, and computing systems. In this regard, some example embodiments provide network-accessible patient health records that may be accessed and exchanged by various healthcare service providers over a network. More particularly, some example embodiments provide patient health records that may be stored anywhere within the cloud such that they are accessible over a public domain network via a resource identifier. In order to maintain privacy and security of patient health records stored in the public domain, some such example embodiments provide for encryption of the public health records such that only authorized parties have access to decryption keys needed to decrypt the records. In this regard, a health record trust entity may hold symmetric keys for decrypting patient health records in escrow and provide the held symmetric keys only to appropriately authorized parties. The health record trust entity of some example embodiments enables patients to define access permissions to their health data. Accordingly, ownership of data exchanged between service providers and other stakeholders may be shifted to the patient.

In a first example embodiment, a method for providing network-accessible patient health records is provided. The method of this example embodiment comprises generating a patient health record document. The method of this example embodiment further comprises obtaining a set of one or more symmetric keys from a health record trust entity. The method of this example embodiment additionally comprises encrypting at least a portion of the patient health record document with the obtained set of symmetric keys. The method of this example embodiment also comprises causing the encrypted patient health record document to be published to a location on a network. The published encrypted patient health record document of this example embodiment has a resource identifier enabling the published encrypted patient health record document to be accessed over the network.

In a second example embodiment, an apparatus for providing network-accessible patient health records is provided. The apparatus of this embodiment comprises at least one processor. The at least one processor is configured to cause the apparatus of this example embodiment to generate a patient health record document. The at least one processor is further configured to cause the apparatus of this example embodiment to obtain a set of one or more symmetric keys from a health record trust entity. The at least one processor is additionally configured to cause the apparatus of this example embodiment to encrypt at least a portion of the patient health record document with the obtained set of symmetric keys. The at least one processor is also configured to cause the apparatus of this example embodiment to cause the encrypted patient health record document to be published to a location on a network. The published encrypted patient health record document of this example embodiment has a resource identifier enabling the published encrypted patient health record document to be accessed over the network.

In a third example embodiment, a computer program product for providing network-accessible patient health records is provided. The computer program product of this example embodiment includes at least one non-transitory computer-readable storage medium having computer-readable program instructions stored therein. The program instructions of this example embodiment comprise program instructions for generating a patient health record document. The program instructions of this example embodiment further comprise program instructions for obtaining of a set of one or more symmetric keys from a health record trust entity. The program instructions of this example embodiment additionally comprise program instructions for encrypting at least a portion of the patient health record document with the obtained set of symmetric keys. The program instructions of this example embodiment also comprise program instructions for causing the encrypted patient health record document to be published to a location on a network. The published encrypted patient health record document of this example embodiment has a resource identifier enabling the published encrypted patient health record document to be accessed over the network.

In a fourth example embodiment, an apparatus for providing network-accessible patient health records is provided. The apparatus of this example embodiment comprises means for generating a patient health record document. The apparatus of this example embodiment further comprises means for obtaining a set of one or more symmetric keys from a health record trust entity. The apparatus of this example embodiment additionally comprises means for encrypting at least a portion of the patient health record document with the obtained set of symmetric keys. The apparatus of this example embodiment also comprises means for causing the encrypted patient health record document to be published to a location on a network. The published encrypted patient health record document of this example embodiment has a resource identifier enabling the published encrypted patient health record document to be accessed over the network.

In a fifth example embodiment, another method for providing network-accessible patient health records is provided. The method of this example embodiment comprises using a resource identifier to access a published encrypted patient health record from a location on a network. The method of this example embodiment further comprises obtaining a set of one or more symmetric keys from a health record trust entity. The obtained set of symmetric keys may be held by the health record trust entity of this example embodiment. The method of this example embodiment additionally comprises decrypting at least a portion of the patient health record document with the obtained set of symmetric keys.

In a sixth example embodiment, another apparatus for providing network-accessible patient health records is provided. The apparatus of this embodiment comprises at least one processor. The at least one processor is configured to cause the apparatus of this example embodiment to use a resource identifier to access a published encrypted patient health record from a location on a network. The at least one processor is further configured to cause the apparatus of this example embodiment to obtain a set of one or more symmetric keys from a health record trust entity. The obtained set of symmetric keys may be held by the health record trust entity of this example embodiment. The at least one processor is additionally configured to cause the apparatus of this example embodiment to decrypt at least a portion of the patient health record document with the obtained set of symmetric keys.

In a seventh example embodiment, another computer program product for providing network-accessible patient health records is provided. The computer program product of this example embodiment includes at least one non-transitory computer-readable storage medium having computer-readable program instructions stored therein. The program instructions of this example embodiment comprise program instructions for using a resource identifier to access a published encrypted patient health record from a location on a network. The program instructions of this example embodiment further comprise program instructions for obtaining a set of one or more symmetric keys from a health record trust entity. The obtained set of symmetric keys may be held by the health record trust entity of this example embodiment. The program instructions of this example embodiment additionally comprise program instructions for decrypting at least a portion of the patient health record document with the obtained set of symmetric keys.

In an eighth example embodiment, another apparatus for providing network-accessible patient health records is provided. The apparatus of this example embodiment comprises means for using a resource identifier to access a published encrypted patient health record from a location on a network. The apparatus of this example embodiment further comprises means for obtaining a set of one or more symmetric keys from a health record trust entity. The obtained set of symmetric keys may be held by the health record trust entity of this example embodiment. The apparatus of this example embodiment additionally comprises means for decrypting at least a portion of the patient health record document with the obtained set of symmetric keys.

In a ninth example embodiment, a further method for providing network-accessible patient health records is provided. The method of this example embodiment comprises receiving, at a health record trust entity, a request from a service provider for a set of one or more symmetric keys for decrypting at least a portion of a published patient health record document. The method of this example embodiment further comprises accessing a set of one or more symmetric keys held by the health record trust entity corresponding to the published patient health record document. The method of this example embodiment additionally providing a subset of the accessed set of symmetric keys to the service provider in response to the request.

In a tenth example embodiment, a further apparatus for providing network-accessible patient health records is provided. The apparatus of this embodiment comprises at least one processor. The at least one processor is configured to cause the apparatus of this example embodiment to receive, at a health record trust entity, a request from a service provider for a set of one or more symmetric keys for decrypting at least a portion of a published patient health record document. The at least one processor is further configured to cause the apparatus of this example embodiment to access a set of one or more symmetric keys held by the health record trust entity corresponding to the published patient health record document. The at least one processor is additionally configured to cause the apparatus of this example embodiment to provide a subset of the accessed set of symmetric keys to the service provider in response to the request.

In an eleventh example embodiment, a further computer program product for providing network-accessible patient health records is provided. The computer program product of this example embodiment includes at least one non-transitory computer-readable storage medium having computer-readable program instructions stored therein. The program instructions of this example embodiment comprise program instructions for receiving, at a health record trust entity, a request from a service provider for a set of one or more symmetric keys for decrypting at least a portion of a published patient health record document. The program instructions of this example embodiment further comprise program instructions for accessing a set of one or more symmetric keys held by the health record trust entity corresponding to the published patient health record document. The program instructions of this example embodiment additionally comprise program instructions for providing a subset of the accessed set of symmetric keys to the service provider in response to the request.

In a twelfth example embodiment, a further apparatus for providing network-accessible patient health records is provided. The apparatus of this example embodiment comprises means for receiving, at a health record trust entity, a request from a service provider for a set of one or more symmetric keys for decrypting at least a portion of a published patient health record document. The apparatus of this example embodiment further comprises means for accessing a set of one or more symmetric keys held by the health record trust entity corresponding to the published patient health record document. The apparatus of this example embodiment additionally comprises means for providing a subset of the accessed set of symmetric keys to the service provider in response to the request.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for providing network-accessible patient health records according to some example embodiments;

FIG. 2 illustrates a block diagram of a health record trust apparatus according to some example embodiments;

FIG. 3 illustrates a block diagram of a service provider apparatus according to some example embodiments;

FIG. 4 illustrates the layers of patient health documentation in accordance with some example embodiments;

FIG. 5 illustrates an example of the sections of a patient health record document and corresponding access permissions that may be defined for the sections in accordance with some example embodiments;

FIG. 6 illustrates operations that may occur to facilitate publishing a network-accessible health record in accordance with some example embodiments;

FIG. 8 illustrates a flowchart according to an example method for providing a network-accessible patient health record document according to some example embodiments;

FIG. 9 illustrates a flowchart according to an example method for accessing a network-accessible patient health record document according to some example embodiments;

FIG. 10 illustrates a flowchart according to an example method for facilitating accessing a network-accessible patient health record document according to some example embodiments; and

FIG. 11 illustrates a flowchart according to a further example method for facilitating accessing a network-accessible patient health record document according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, and/or the like.

As previously discussed, conventional information technology approaches for implementing electronic patient health records put information into closed (e.g., siloed), protected systems surrounded by firewalls and other layers of security. These conventional systems do not easily scale to the size necessary to cover the country's population and they cannot provide access and grant full control to individual patients without compromising their security regimes.

As such, some example embodiments disclosed herein advantageously address these and other deficiencies of current electronic patient health record systems. In this regard, some example embodiments provide patients with access to, and control over their own medical information by moving the patient's medical information into the public domain while maintaining privacy and security. More particularly, some example embodiments provide for secure storage of patient health records anywhere within a public domain network (e.g., within “the cloud”) that is accessible by a resource identifier, such as a uniform resource locator (URL), or the like.

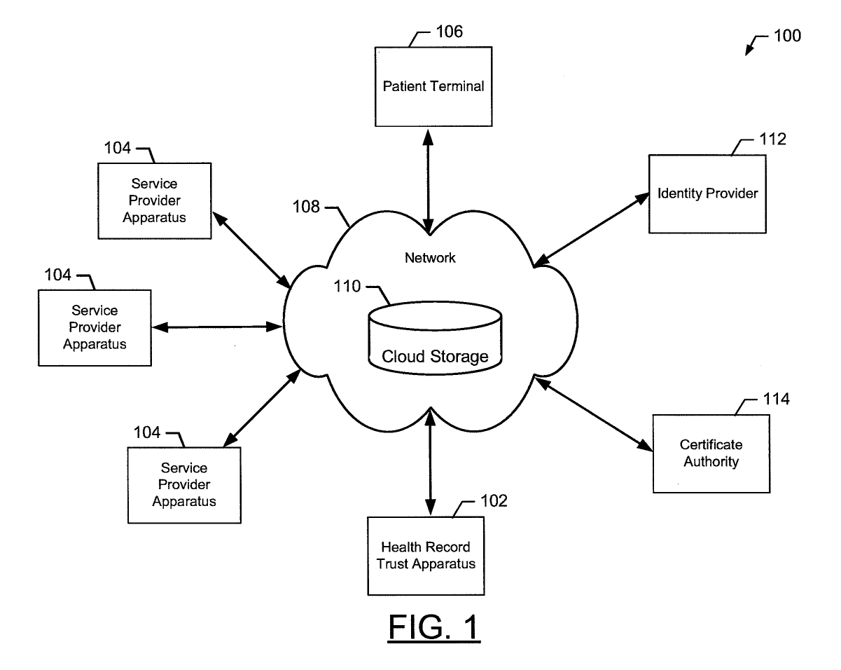

Referring now to FIG. 1, FIG. 1 illustrates a system 100 for providing network-accessible patient health records according to some example embodiments. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing network-accessible patient health records, numerous other configurations may also be used to implement embodiments of the present invention.

In the system of FIG. 1, patient health records may be semantically networked. In this regard, in the system 100, a patient's health records may exist in the public domain, accessible on a network, such as the internet. More particularly, patient health record documents may be stored within a cloud storage 110 that may reside within a network 108. The network 108 may comprise one or more wireless networks (e.g., a cellular network, wireless local area network, wireless metropolitan area network, and/or the like), one or more wireline networks (e.g., a wired local area network), or some combination thereof, and in some embodiments comprises at least a portion of the internet. It will be appreciated that the cloud storage 110 may comprise any location or plurality of locations on the network 108 on which patient health record documents may be stored and accessed via respective resource identifiers. In this regard, the cloud storage 110 may be supported by a “cloud” computing model supporting dynamically scalable and highly virtualized storage resources.

Security of patient health record documents stored within the public domain on the cloud storage 110 may be maintained using a layered security approach. This layered security may include encryption of the public domain documents, such as through the use of extensible markup language (XML) encryption and XML signature. Access to symmetric or other decryption keys that may be needed by a service provider apparatus 104 to decrypt an encrypted patient health record document may be controlled by a Health Record Trust (HRT) entity, which may operate a Health Record Trust (HRT) apparatus 102. As will be further described, the HRT apparatus 102 may authenticate a service provider apparatus 104 or other entity seeking access to encryption keys for a patient health record document before distributing appropriate decryption keys to the requesting entity. Such identity verification may be facilitated through the use of Information Card Identity Management (ICard) authentication and/or other appropriate protocol. Further, the HRT apparatus 102 may leverage Public Key Infrastructure (PKI) to provide secure key exchange between the HRT apparatus 102 and a service provider apparatus 104.

Accordingly, it will be appreciated that in some example embodiments, the system 100 includes an HRT apparatus 102 and one or more service provider apparatuses 104 configured to communicate over the network 108. A service provider apparatus 104 may comprise any computing device that may be used by a service provider to produce and/or access a patient health care document. By way of example, a service provider that may operate a service provider apparatus 104 may include a physician's office, hospital, lab, therapist, pharmacy, insurance provider, patient guarantor, and/or other medical service provider.

The health record trust apparatus 102 may be embodied as any computing device or plurality of computing devices configured to perform at least some functionality of an HRT entity, as described herein. In this regard, the health record trust apparatus 102 may comprise an apparatus or plurality of apparatuses operated by an agency or entity providing HRT services in accordance with one or more example embodiments. By way of non-limiting example, the HRT apparatus 102 may be embodied as one or more servers, a server cluster, a cloud computing infrastructure, one or more network nodes, multiple computing devices in communication with each other, any combination thereof, and/or the like.

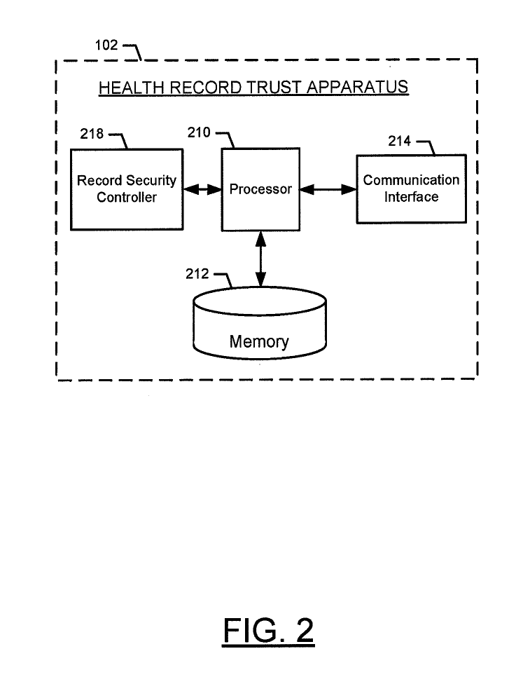

FIG. 2 illustrates a block diagram of a health record trust (HRT) apparatus 102 according to some example embodiments. In some example embodiments, the health record trust apparatus 102 includes various means for performing the various functions described herein. These means may include, for example, one or more of a processor 210, memory 212, communication interface 214, or record security controller 218. The means of the health record trust apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 212) that is executable by a suitably configured processing device (e.g., the processor 210), or some combination thereof.

The processor 210 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of processors implemented in hardware, or some combination thereof. Accordingly, although illustrated in FIG. 2 as a single processor, in some embodiments the processor 210 may comprise a plurality of processors. The plurality of processors may be embodied on a single computing device or may be distributed across a plurality of computing devices collectively configured to function as the health record trust apparatus 102. The plurality of processors may be in operative communication with each other and may be collectively configured to perform one or more functionalities of the health record trust apparatus 102 as described herein. In some example embodiments, the processor 210 is configured to execute instructions stored in the memory 212 or otherwise accessible to the processor 210. These instructions, when executed by the processor 210, may cause the health record trust apparatus 102 to perform one or more of the functionalities of the health record trust apparatus 102 as described herein. As such, whether configured by hardware or software methods, or by a combination thereof, the processor 210 may comprise an entity capable of performing operations according to embodiments of the present invention while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may include, for example, volatile and/or non-volatile memory. Although illustrated in FIG. 2 as a single memory, the memory 212 may comprise a plurality of memories. The plurality of memories may be embodied on a single computing device or distributed across a plurality of computing devices. The memory 212 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 212 may comprise any non-transitory computer readable storage medium. The memory 212 may be configured to store information, data, applications, instructions, or the like for enabling the health record trust apparatus 102 to carry out various functions in accordance with example embodiments of the present invention. For example, in some example embodiments, the memory 212 is configured to buffer input data for processing by the processor 210. Additionally or alternatively, in some example embodiments, the memory 212 is configured to store program instructions for execution by the processor 210. The memory 212 may store information in the form of static and/or dynamic information. For example, the memory 212 may store symmetric encryption/decryption keys that may be used to encrypt/decrypt patient health record documents. This stored information may be stored and/or used by the record security controller 218 during the course of performing its functionalities.

The communication interface 214 may be embodied as any device or means embodied in circuitry, hardware, a computer program product comprising computer readable program instructions stored on a computer readable medium (e.g., the memory 212) and executed by a processing device (e.g., the processor 210), or a combination thereof that is configured to receive and/or transmit data from/to another device, such as, for example, a service provider apparatus 104, patient terminal 106, identity provider 112, certificate authority 114, and/or the like. In some example embodiments, the communication interface 214 is at least partially embodied as or otherwise controlled by the processor 210. In this regard, the communication interface 214 may be in communication with the processor 210, such as via a bus. The communication interface 214 may include, for example, an antenna, a transmitter, a receiver, a transceiver and/or supporting hardware or software for enabling communications with another computing device. The communication interface 214 may be configured to receive and/or transmit data using any protocol that may be used for communications between computing devices. As an example, the communication interface 214 may be configured to receive and/or transmit data using any protocol and/or communications technology that may be used for communicating over the network 108. The communication interface 214 may additionally be in communication with the memory 212, and/or record security controller 218, such as via a bus.

The record security controller 218 may be embodied as various means, such as circuitry, hardware, a computer program product comprising computer readable program instructions stored on a computer readable medium (e.g., the memory 212) and executed by a processing device (e.g., the processor 210), or some combination thereof and, in some example embodiments, is embodied as or otherwise controlled by the processor 210. In embodiments wherein the record security controller 218 is embodied separately from the processor 210, the record security controller 218 may be in communication with the processor 210. The record security controller 218 may further be in communication with one or more of the memory 212 or communication interface 214, such as via a bus.

As will be described in further detail below, the HRT apparatus 102 may provide several services in order to facilitate the provision of network-accessible patient health records in accordance with various example embodiments. Among those services provided by the HRT apparatus 102 in accordance with some example embodiments are services that may be broken down into two levels. At a first level, the HRT apparatus 102 may serve as an access arbiter to facilitate maintaining the security of patient health record documents stored in the cloud storage 110. In this regard, in some example embodiments, the HRT apparatus 102 functions as an authority responsible for credentialing and certifying participating entities' identities for authentication exchanges. For example, the record security controller 218 may be configured to authenticate a service provider apparatus 104 seeking access to a patient health record document that may be stored in the cloud storage 110 to ensure that the service provider has access permissions for viewing at least a portion of the patient's medical data. It will be appreciated that any appropriate authentication protocol considered sufficiently strong to protect security of patient health record documents may be used for authentication of a service provider. By way of example, any authentication protocol used for authentication in commercial business-to-business interactions may be used. For example, in some example embodiments, the record security controller 218 is configured to use Information Card Identity Management (ICard) for authentication of a service provider.

Further attendant to its security functions, in some example embodiments, the HRT apparatus 102 may assume management of a Public Key Infrastructure (PKI) that may be used to facilitate provisioning of encryption and/or decryption keys (e.g., symmetric keys) to service providers publishing and/or accessing patient health record documents. In some example embodiments, the HRT apparatus 102 may be configured to manage the provisioning of service providers (e.g., service provider apparatuses 104) and/or other entities of the system 100 with their public key certificates that may be used for secure information exchange, such as exchange of symmetric keys between the HRT apparatus 102 and a service provider apparatus 104.

Alternatively, in other example embodiments, the responsibility for provisioning of public key certificates may be at least partially offloaded from the HRT apparatus 102 to a third-party PKI provider. In this regard, the system 100 may additionally comprise an identity provider 112 and/or certificate authority 114, which may provide PKI services for facilitating secure information exchange among entities of the system 100. In embodiments wherein PKI functionality is offloaded from the HRT apparatus 102 to a third-party PKI provider, it will be appreciated that the identity provider 112 may comprise any entity configured to provide a security token or other verifiable identity to an entity of the system 100, while the certificate authority 114 may comprise any entity configured to issue a public key certificate to a service provider 104 and/or other entity of the system 100 and to provide a copy of an issued public key certificate to a requesting entity, such as the HRT apparatus 102. As such, it will be appreciated that in accordance with various example embodiments, a public key certificate may be issued directly by the HRT apparatus 102, or may be issued by a certificate authority 114 that may be maintained by a third-party PKI provider.

Additionally, the record security controller 218 associated with the HRT apparatus 102 may be configured to generate symmetric keys (e.g., encryption and/or decryption keys) that may be used for encrypting (e.g., XML encryption) and decrypting patient health record documents that may be stored in the cloud storage 110. These generated keys, document mapping, and/or other information needed to allow a service provider to access and/or produce a patient health record document on behalf of a patient may be maintained in escrow in the memory 112.

For example, the record security controller 218 may receive a request from a service provider apparatus 104 for a set of one or more symmetric keys for use to encrypt a patient health record document prior to publishing the document. The record security controller 218 may generate a set of one or more symmetric keys for encrypting and decrypting the patient health record document in response to the request. In some embodiments, the generated set of symmetric keys may comprise a single set of keys which may be used for both encryption and decryption. In other embodiments, the generated set of symmetric keys may comprise a first set for encryption, and a second set for decryption. The record security controller 218 may send the set of symmetric keys for encrypting the patient health record document to the requesting service provider apparatus 104. In some example embodiments, the sent set of symmetric keys may be encrypted with a public key certificate of the requesting service provider. The record security controller 218 may further store the symmetric keys in escrow in the memory 112. If the set of symmetric keys includes multiple symmetric keys, which are each mapped to a particular section of the patient health record document, the record security controller 218 may further store a document mapping that maps individual keys to respective document sections.

As a further example, the record security controller 218 may be configured to receive a request for a set of one or more symmetric keys from a service provider apparatus 104 for use in decrypting a patient health record document. The request may, for example, include a resource identifier for the patient health record document, a patient identifier (e.g., the patient's social security number), and/or the like to enable the record security controller 218 to retrieve the set of corresponding symmetric keys for the patient health record document. The record security controller 218 may access the set of one or more symmetric keys corresponding to the patient health record document and, depending on the access permissions granted to the requesting service provider, may provide the service provider with a subset of the set of symmetric keys. For example, each symmetric key may be associated with a different section of the patient health record document, and the requesting service provider may only have permission to access a subset of the sections of the health record document. Accordingly, the record security controller 218 may be configured to provide the requesting service provider only with the symmetric key(s) corresponding to the section(s) which the service provider is authorized to view. The record security controller 218 may encrypt a set of symmetric keys sent to a requesting service provider apparatus 104 with the public key certificate of the service provider.

At a second level, the HRT apparatus 102 is configured in some example embodiments to provide a portal for a patient and/or his or her related guarantor and interested parties to manage the patient's networked health records. For example, the HRT apparatus 102 may provide a web page or other network-accessible portal allowing a patient to log in and manage a list of partner service provider entities. These partner service provider entities may include any medical service provider that may be used by the patient, such as, for example, the patient's physician office, insurance company, hospital, therapist, a lab, a pharmacy, and/or the like. Accordingly, it will be appreciated that the patient's partner service provider entities may operate respective service provider apparatuses 104 for producing and/or accessing health record documents associated with the patient. In managing the patient's partner service provider entities via the portal, the patient may manage what portion(s) of his or her medical records that a given service provider may access. For example, the patient may restrict an insurance provider from viewing certain portions of his or her medical records that may not be needed for the insurer to process a claim.

The portal may additionally allow the patient to access and view his or her medical records. For example, the patient may view current claims pending to their insurance provider, recent lab results, prescription information, physician diagnoses, and/or the like. If a patient has an associated guarantor, the guarantor may also have the ability to review the patient's medical records via a portal provided by the HRT apparatus 102 through an authentication relationship with the patient.

A user may access the portal provided by the HRT apparatus 102 in accordance with some example embodiments by way of any computing device appropriately configured to access the portal over the network 108. In this regard, the system 100 may comprise one or more patient terminals 106 that a patient may use to access his or her health record portal that may be provided by the HRT apparatus 102. A patient terminal 106 may accordingly comprise any appropriately configured computing device capable of accessing the portal over the network 108. By way of non-limiting example, a patient terminal 106 may be embodied as a desktop computer, a laptop computer, a mobile computer, a mobile phone, a tablet computing device, or the like.

The HRT apparatus 102 may further maintain a set of patient demographic and/or registration information for a patient using services of the HRT apparatus 102. The demographic and/or registration information may be shared with service providers and/or other stakeholders within the confines of privacy restrictions that may be imposed by the patient and/or by applicable privacy laws. The HRT apparatus 102 does not, however, locally store patient health record documents, as these documents are stored in accordance with some example embodiments in the public domain in the cloud storage 110.

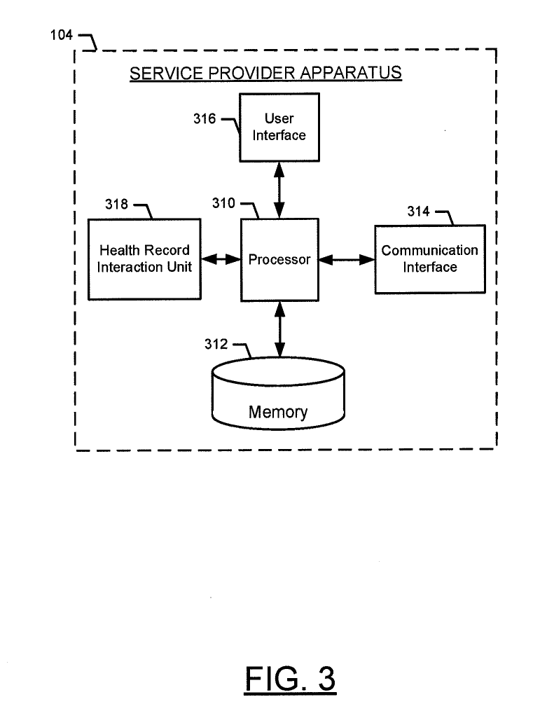

By way of non-limiting example, a service provider apparatus 104 may be embodied as one or more servers, a server cluster, a cloud computing infrastructure, one or more desktop computers, one or more laptop computers, one or more mobile computers, one or more network nodes, multiple computing devices in communication with each other, any combination thereof, and/or the like. FIG. 3 illustrates a block diagram of a service provider apparatus 104 according to some example embodiments. In some example embodiments, the service provider apparatus 104 includes various means for performing the various functions described herein. These means may include, for example, one or more of a processor 310, memory 312, communication interface 314, user interface 316, or health record interaction unit 318 for performing the various functions herein described. The means of the service provider apparatus 104 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 312) that is executable by a suitably configured processing device (e.g., the processor 310), or some combination thereof.

The processor 310 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 310 may comprise a plurality of processors. The plurality of processors may be embodied on a single computing device or may be distributed across a plurality of computing devices collectively configured to function as the service provider apparatus 104. The plurality of processors may be in operative communication with each other and may be collectively configured to perform one or more functionalities of the service provider apparatus 104 as described herein. In some example embodiments, the processor 310 is configured to execute instructions stored in the memory 312 or otherwise accessible to the processor 310. These instructions, when executed by the processor 310, may cause the service provider apparatus 104 to perform one or more of the functionalities of the service provider apparatus 104 as described herein. As such, whether configured by hardware or software methods, or by a combination thereof, the processor 310 may comprise an entity capable of performing operations according to embodiments of the present invention while configured accordingly. Thus, for example, when the processor 310 is embodied as an ASIC, FPGA or the like, the processor 310 may comprise specifically configured hardware for conducting one or more operations described herein. Alternatively, as another example, when the processor 310 is embodied as an executor of instructions, such as may be stored in the memory 312, the instructions may specifically configure the processor 310 to perform one or more algorithms and operations described herein.

The memory 312 may include, for example, volatile and/or non-volatile memory. Although illustrated in FIG. 3 as a single memory, the memory 312 may comprise a plurality of memories. The plurality of memories may be embodied on a single computing device or distributed across a plurality of computing devices. The memory 312 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 312 may comprise any non-transitory computer readable storage medium. The memory 312 may be configured to store information, data, applications, instructions, or the like for enabling the service provider apparatus 104 to carry out various functions in accordance with example embodiments of the present invention. For example, in some example embodiments, the memory 312 is configured to buffer input data for processing by the processor 310. Additionally or alternatively, in some example embodiments, the memory 312 is configured to store program instructions for execution by the processor 310. The memory 312 may store information in the form of static and/or dynamic information. This stored information may be stored and/or used by the health record interaction unit 318 during the course of performing its functionalities.

The communication interface 314 may be embodied as any device or means embodied in circuitry, hardware, a computer program product comprising computer readable program instructions stored on a computer readable medium (e.g., the memory 312) and executed by a processing device (e.g., the processor 310), or a combination thereof that is configured to receive and/or transmit data from/to another device, such as, for example, another service provider apparatus 104, an HRT apparatus 102, patient terminal 106, identity provider 112, certificate authority 114, and/or the like and/or the like. In some example embodiments, the communication interface 314 is at least partially embodied as or otherwise controlled by the processor 310. In this regard, the communication interface 314 may be in communication with the processor 310, such as via a bus. The communication interface 314 may include, for example, an antenna, a transmitter, a receiver, a transceiver and/or supporting hardware or software for enabling communications with another computing device. The communication interface 314 may be configured to receive and/or transmit data using any protocol that may be used for communications between computing devices. As an example, the communication interface 314 may be configured to receive and/or transmit data using any protocol and/or communications technology that may be used for communicating over the network 108. The communication interface 314 may additionally be in communication with the memory 312, user interface 316, and/or health record interaction unit 318, such as via a bus.

The user interface 316 may be in communication with the processor 310 to receive an indication of a user input and/or to provide an audible, visual, mechanical, or other output to a user. As such, the user interface 316 may include, for example, a keyboard, a mouse, a joystick, a display, a touch screen display, a microphone, a speaker, and/or other input/output mechanisms. In embodiments wherein a respective service provider apparatus 104 is embodied as a server, aspects of the user interface 316 associated with the respective service provider apparatus 104 may be limited, or the user interface 316 may be eliminated entirely. The user interface 316 may be in communication with the memory 312, communication interface 314, and/or health record interaction unit 318, such as via a bus.

The health record interaction unit 318 may be embodied as various means, such as circuitry, hardware, a computer program product comprising computer readable program instructions stored on a computer readable medium (e.g., the memory 312) and executed by a processing device (e.g., the processor 310), or some combination thereof and, in some example embodiments, is embodied as or otherwise controlled by the processor 310. In embodiments wherein the health record interaction unit 318 is embodied separately from the processor 310, the health record interaction unit 318 may be in communication with the processor 310. The health record interaction unit 318 may further be in communication with one or more of the memory 312, communication interface 314, or user interface 316, such as via a bus.

The health record interaction unit 318 associated with a service provider apparatus 104 may be configured to generate a patient health record document. The content and type of a generated patient health record document may vary depending on the type of service provider operating the service provider apparatus 104 generating the patient health record document. For example, a physician or other provider of medical treatment services may generate a medical record of an encounter. As another example, a medical service provider may generate a document outlining treatment costs, outstanding account balance (e.g., reflecting payments from an insurer, the patient, a guarantor, and/or the like), an insurance claim document, and/or the like. As still a further example, an insurer may generate an explanation of benefits reflecting the insurer's share of a claim.

The health record interaction unit 318 may obtain a set of one or more symmetric keys from the HRT apparatus 102 to use to encrypt at least a portion of the patient health record document prior to publishing the patient health record document. In some example embodiments, the set of symmetric keys received from the HRT apparatus 102 may be encrypted with a public key certificate of the service provider apparatus 104. In such embodiments, the health record interaction unit 318 may be configured to use a private key of the service provider apparatus 104 to decrypt the encrypted symmetric keys.

The health record interaction unit 318 may use the received set of symmetric keys to encrypt at least a portion of the patient health record document. In some example embodiments, the generated patient health record document may comprise a plurality of sections, and the received set of symmetric keys may include a symmetric key corresponding to each respective section. In such embodiments, the health record interaction unit 318 may encrypt each section with its corresponding symmetric key. In this regard, after the health record document is published in the public domain, access to sections of the health record document may be controlled by the HRT apparatus 102 on the basis of the scope of access permissions granted to an entity requesting symmetric keys for decrypting the health record document.

After the patient health record document has been at least partially encrypted, the health record interaction unit 318 may cause the encrypted patient health record document to be published in the public domain at a location on the cloud storage 110. The location to which the patient health record document is published may be associated with a resource identifier, thereby enabling another service provider or other entity to access the published health record document over the network 108. For example, a resource identifier for a published patient health record document may comprise a URL, such as: http://www.healtheast.org//providerRecords/Document_{—}12ab45cd.xml.

A service provider apparatus 104 seeking to access a published patient health record document may accordingly use the resource identifier of the document to access the document over the network 108. The health record interaction unit 318 associated with a service provider apparatus 104 accessing the published document may be configured to obtain a set of one or more symmetric keys form the HRT apparatus 102 to enable the health record interaction unit 318 to decrypt information contained in the accessed patient health record document. In some example embodiments, the set of symmetric keys for decrypting the patient health record document received from the HRT apparatus 102 may be encrypted with a public key certificate of the requesting service provider. In such embodiments, the health record interaction unit 318 may be configured to use the private key of the requesting service provider to decrypt the received symmetric key(s). The health record interaction unit 318 may use the obtained symmetric key(s) to decrypt at least a portion of the accessed patient health record document.

In embodiments wherein the accessed patient health record document includes a plurality of sections encrypted with respective symmetric keys, the health record interaction unit 318 associated with a service provider apparatus 104 accessing the document may decrypt a respective section of the patient health record document with the symmetric key associated with that section. In this regard, the health record interaction unit 318 may have access to a map mapping a set of symmetric keys to respective sections of the document, and may use this map to determine the appropriate symmetric key to use for decrypting a respective section of the document. This map may, for example, be provided by the HRT apparatus 102 and/or by the service provider that generated and published the patient health record document. For example, in some example embodiments wherein a single set of symmetric keys exists for a patient health record document that are capable of being used for both encryption and decryption, the map may be provided by the service provider that generated and published the patient health record document. Alternatively, in some example embodiments wherein two sets of symmetric keys—one for encryption, and another for decryption—exist for a patient health record document, the map may be provided by the HRT apparatus 102.

In some such example embodiments, the set of symmetric keys obtained by a service provider for decrypting a patient health record document may be limited based on the scope of access permissions granted to the requesting service provider. Accordingly, an entity accessing a published patient health record document may only receive symmetric key(s) corresponding to the section(s) of the document that the entity is authorized to view.

In some example embodiments, the health record interaction unit 318 associated with a service provider apparatus 104 may be configured to generate a patient health record document in accordance with a defined standardized ontology. In this regard, in some example embodiments, while a service provider may manage health data internally in a proprietary format, published network-accessible patient health record documents may be formatted in accordance with a standardized ontology facilitating information exchange among service providers and other stakeholders.

In this regard, the common ontology of some example embodiments may describe medical record relationships across the clinical and patient accounting domains. The ontology may provide for medical data capture in a World Wide Web Consortium (W3C) standard resource description format (RDF). Participating entities (e.g., participating service providers) may be required to both accept data in this format and publish new data into the patient record in this format. The published form of the RDF data of some example embodiments is specified as “RDF/XML,” which can be encrypted using XML encryption technology. XML Signature technology may further be employed by a service provider when publishing the medical records, thereby supporting authenticity, integrity and non-repudiation of the records.

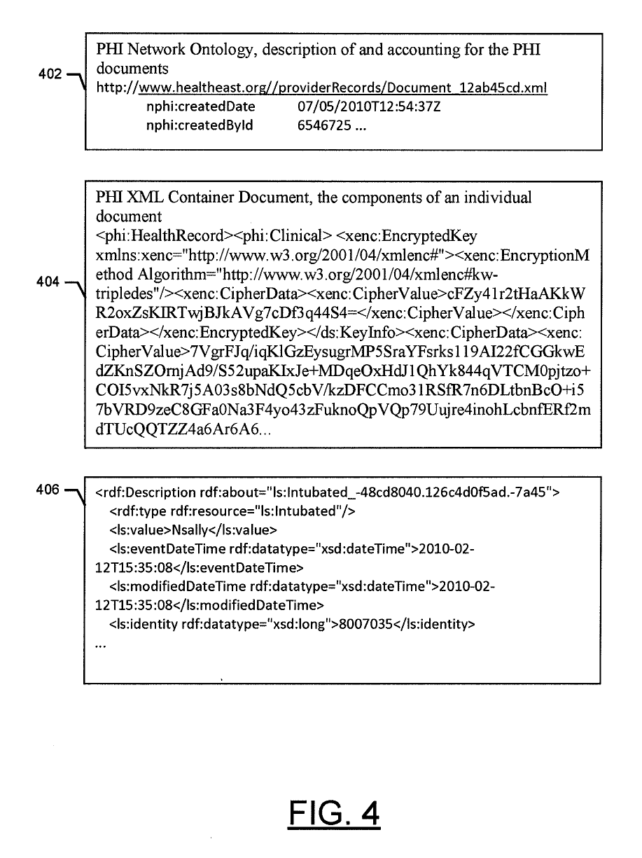

The patient health documentation of some example embodiments exists in three layers. In this regard, FIG. 4 illustrates the three layers of patient health documentation in accordance with some example embodiments. The first layer may comprise a document organization layer, which may contain RDF unique resource identifiers for individual documents with triple-based instance data about each respective document. An example of the first layer of some example embodiments is illustrated in the section 402 of FIG. 4. The triple-based instance data may cover document provenance without direct patient identification. The first layer 402 may additionally include an archives reference to the HRT apparatus 102, which may enable an entity accessing a published patient health record document to obtain the appropriate set of escrowed symmetric keys for decrypting document components.

The second layer of some example embodiments consists of the document components representing individually encrypted sections permitting selective access based on possession of appropriate symmetric keys. An example of the second layer of some example embodiments is illustrated in the section 404 of FIG. 4. The sections correspond to the high-level classes of the ontology of such example embodiments. However, some consolidation of multiple high-level classes into a single document section may be used in some example embodiments for efficiency. A consideration in defining these components is that the data they contain are discrete yet sufficient for the purposes of the recipient stakeholder. A component defined too broadly may expose more information to an entity than is intended or necessary for a given purpose. However, a component defined too narrowly could force the recipient to require multiple components leading to additional key management and data publishing overhead. Accordingly, the component model design in accordance with the record ontology of some example embodiments seeks to strike a balance between defining components too broadly and defining components too narrowly. The components of some example embodiments, which may be used to define the sections of a patient health record document include:

Demographic

Cohort

Insurance

Account

Clinical

Prescription

Allergy

The third layer of some example embodiments defines, within each document component, an OWL (Web Ontology Language)-modeled, RDF representation of the entity-specific health record data. An example of the third layer of some example embodiments is illustrated in the section 406 of FIG. 4. For example, an insurer may contribute an explanation of benefits in the insurance component section against claims made by the provider in the insurance and clinical sections. The ontology of some example embodiments includes the following top-level classes which may be used within respective components for organization of health record data:

Person

Encounter

Cohort

Guarantor

InterestedParty

Payor

Plan

Contract

MedicalNecessity

Reimbursement

Remittance

Procedure

Observation

Finding

Drug

Order

Compliance

Pharmacy

AccountAudit

CoachingScreening

Over the lifespan of a patient health record publication, various stakeholders can gain access to the document through access permission references maintained by the HRT apparatus 102. While much of the access to documents related to a given episode of care may generally occur within a few months of the care event, the documents may continue to exist in the public domain for several years, or longer, depending on medical and legal requirements.

As discussed previously, the ontology of some example embodiments provides for a plurality of defined containers, or sections, into which a patient health record may be divided to facilitate both organization of patient data and arbitration of access rights. In this regard, each section may be encrypted with a different key such that the HRT apparatus 102 may provide an entity requesting symmetric keys for decrypting a published patient health record document with only a subset of the symmetric keys for the document which correspond with the section(s) of the document that the entity has permission to access.

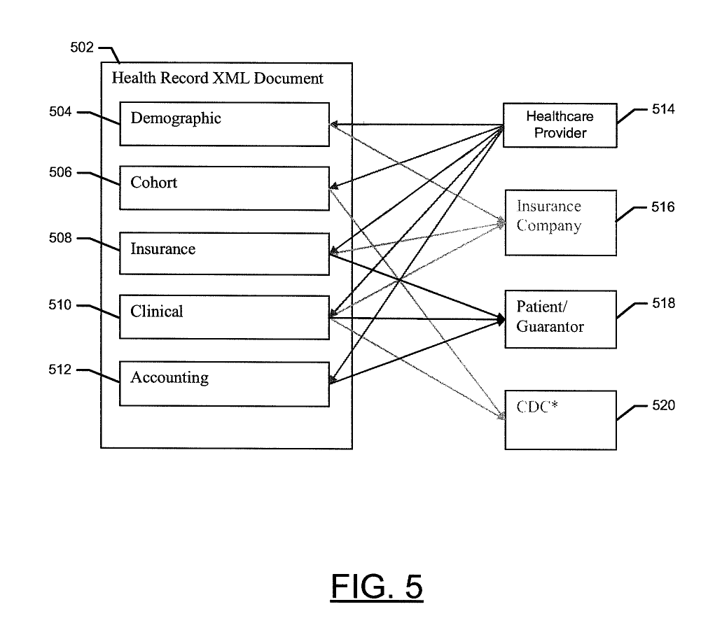

FIG. 5 illustrates an example of the sections of a patient health record document and corresponding access permissions that may be defined for the sections in accordance with some example embodiments. The sections of the patient health record document 502 may correspond to the top-level classes of the ontology of some example embodiments. In this regard, the document 502 may include a demographic section 504, cohort section 506, insurance section 508, clinical section 510, and accounting section 512. Each of the sections 504-512 may be encrypted with a different key. The HRT apparatus 102 may accordingly maintain the symmetric keys for the document 502 in escrow along with a map mapping the symmetric keys to respective sections of the document 502. For example, the HRT apparatus 102 may maintain the following information for the document 502, including the resource identifier for the document and the key map mapping symmetric keys to the respective sections of the document:

http://www.healtheast.org//providerRecords/Document 12ab45cd.xml

| | |
|---|---|
| nphi:createdDate | 07/05/2010T12:54:37Z |
| nphi:createdById | 6546725 |
| nphi:keymap | [ |

| | |
|---|---|
| Demographic | 4e8c3324f09e2a34 (sample AES 256 bit key*), |
| Cohort | 3ac5d6e24fe09234, |
| Insurance | 4c5ac6d7e7409234, |
| Account | 144c3f2e4ab09234, |
| Clinical | 79a87b24ced09234, |
| Pharmacy | 89672409bbeac234, |
| Allergy | 43252f4e0cd9a234 |
| ] | |

nphi:history

In addition, the HRT apparatus 102 may maintain a record of access permissions for the document 502 such that when an entity requests symmetric keys for decrypting the document 502, the record security controller 218 associated with the HRT apparatus 102 may determine the subset of the symmetric keys corresponding to the sections of the document 502 that the entity is permitted to access. In the example of FIG. 5, four example stakeholders that may access the document 502 are illustrated. The health care provider 514 may have access permissions for each of the sections 504-512. In this regard, the health care provider 514 may comprise a physician or other health care provider that may generate the document 502 as a record of a medical encounter treating a patient. The insurance company 516 may have access to the demographic section 504, insurance section 508, and clinical section 510. In this regard, the insurance company 516 may have access to those sections of the document 502 that may be needed to process a claim. The patient and/or the patient's guarantor 518 may have access to the insurance section 508, clinical section 510, and accounting section 512. Accordingly, the patient may view insurance claims, clinical results from the medical encounter, accounting information (e.g., account balance), and/or the like.

Some example embodiments may further provide for a public health interest entity, such as the Center for Disease Control (CDC) 520, to view an anonymized section of patient data. In this regard, the cohort section 506 may include non-identifying information that may classify the patient within one or more groups (e.g., male of age 45). Data in the clinical section 510 may also be in a de-identified form such that a patient identity may not be determined from data in the clinical section 510 alone. A public health interest may accordingly be permitted to access information in the cohort section 506 and clinical results in the clinical section 510 to facilitate tracking public health trends, such as for purposes of policy making decisions.

Having now described the provisioning of network-accessible patient health record documents in accordance with some example embodiments, several context-specific examples of transactions involving the generation and access of patient health record documents in accordance with some example embodiments will now be described by way of example.

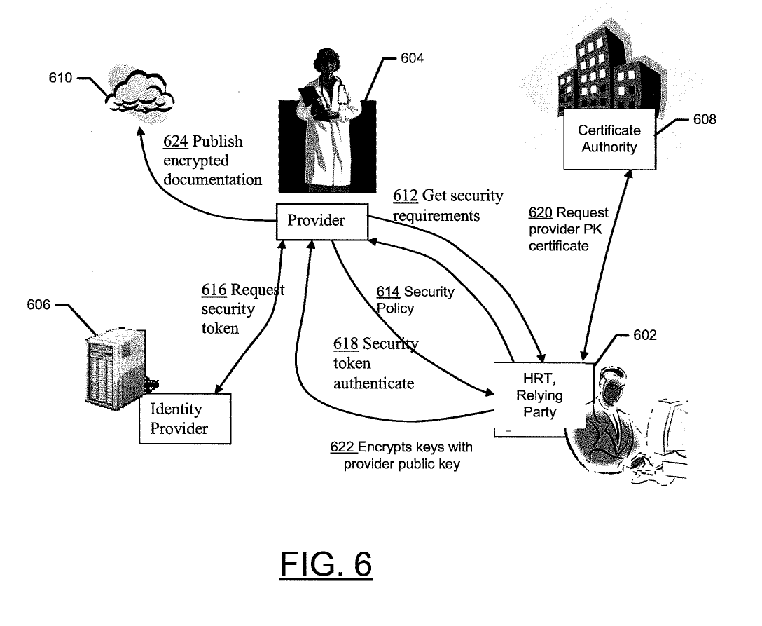

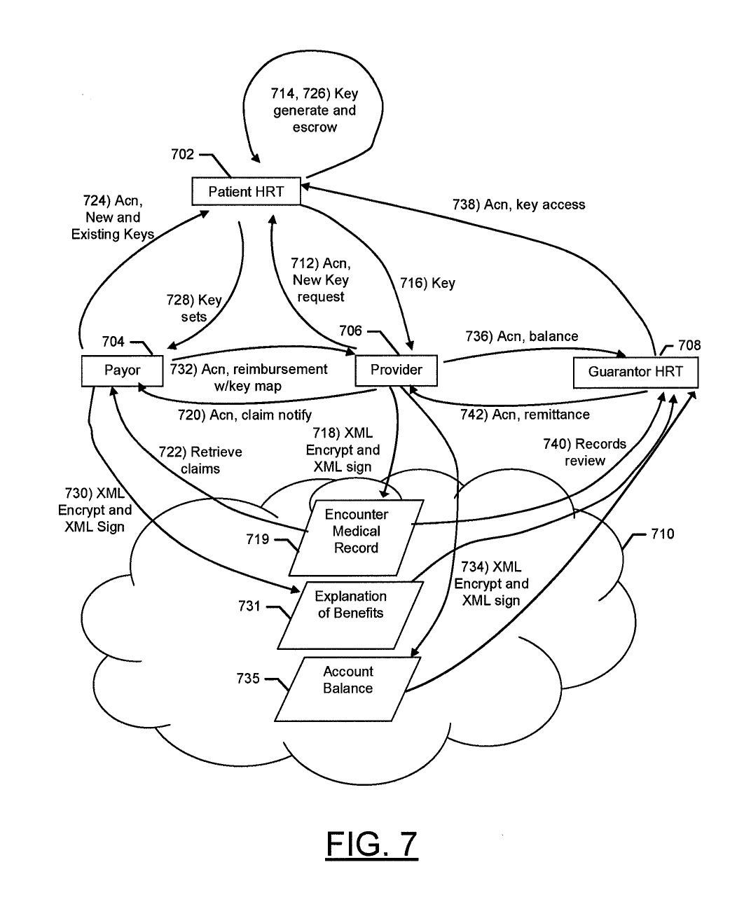

FIG. 6 illustrates operations that may occur to facilitate publishing a network-accessible health record in accordance with some example embodiments. FIG. 6 illustrates operations that may occur in a system, such as the system 100 of FIG. 1. In this regard, FIG. 6 includes an HRT 602, which may comprise an embodiment of the HRT apparatus 102. Accordingly, operations attributed to the HRT 602 may, for example, be performed by and/or under the control of a record security controller 218 that may be associated with the HRT 602. FIG. 6 further includes a health care provider entity 604, which may comprise an embodiment of a service provider apparatus 104. As such, operations attributed to the provider entity 604 may, for example, be performed by and/or under the control of a health record interaction unit 318 that may be associated with the provider entity 604. FIG. 6 additionally includes an identity provider 606 and certificate authority 608, which may be either provided by a third-party PKI service provider, or may be implemented by the HRT 602. FIG. 6 also includes a cloud storage 610, which may comprise an embodiment of the cloud storage 110. Operation 612 may comprise the provider 604 requesting the security requirements for authenticating the provider's identity to the HRT 602. In this regard, the HRT 602 may comprise a “relying party,” which relies on security credentials presented by the provider 604 for authentication. The HRT 602 may return the security policy for authentication of the provider's identity, at operation 614. The security policy may detail the credentials needed to complete an authentication with the HRT 602. The provider 604 may request a security token from the identity provider 606 on the basis of the security policy, at operation 616. The security token may comprise a secure token representing the set of credentials requested in the security policy received from the HRT 602. Operation 618 may comprise the provider 604 providing the security token received from identity provider 606 to the HRT 602 in order to authenticate the provider's identity to the HRT 602. This authentication may, for example, be performed in accordance with ICard protocol. However, it will be appreciated that other appropriate authentication protocols may be substituted for ICard in other embodiments.

The HRT 602 may verify the provider's identity on the basis of the security token received in operation 618. Assuming the provider's identity is properly verified, the HRT 602 may generate a set of symmetric keys for encrypting a patient health record document generated by the provider 604. In some example embodiments, the generated set of symmetric keys may be used for both decryption and encryption. Alternatively, the HRT 602 may generate a corresponding set of symmetric keys for decrypting the patient health record document. The HRT 602 may escrow symmetric keys for decrypting the patient health record document. Accordingly, when another entity having permission to access at least a portion of the patient health record document requests symmetric keys for decrypting the document, the HRT 602 may provide those symmetric keys corresponding to the access permissions granted to the entity.

The HRT 602 may obtain the provider's public key certificate from the certificate authority 608, at operation 620, and may use the obtained public key certificate to encrypt the symmetric keys for encrypting the patient health record document and may provide the encrypted symmetric keys to the provider 604, at operation 622. The provider 604 may decrypt the encrypted symmetric keys with its private key and may use the symmetric keys to encrypt the patient health record document. In embodiments wherein the document comprises a plurality of respective sections, the symmetric keys may be mapped to respective sections. Accordingly, the provider 604 may encrypt each section of the document to be encrypted with the appropriate corresponding symmetric key. At operation 624, the provider 604 may publish the encrypted patient health record document to the cloud storage 610. In this regard, the document may be published to a location having a resource identifier accessible over the public domain.

FIG. 7 illustrates publishing of network-accessible patient health record documents and interaction with those documents by stakeholders in accordance with some example embodiments. In this regard, FIG. 7 illustrates interactions among a system including a patient HRT (“the HRT”) 702 and a plurality of stakeholders in the patient's medical care. These stakeholders may include a payor (e.g., an insurance provider) 704, provider (e.g., a physician or other health care provider) 706, and a guarantor 708. The system of FIG. 7 may, for example, be implemented within the context of the system 100. In this regard, the HRT 702 may comprise an embodiment of the HRT apparatus 102. Accordingly, operations attributed to the HRT 702 may, for example, be performed by and/or under the control of a record security controller 218 that may be associated with the HRT 702. The payor 704, provider 706, and guarantor 708 may each be implemented on respective service provider apparatuses 104. As such, operations attributed to the payor 704, provider 706, and/or guarantor 708 may be performed by a respective associated health record interaction unit 318. The cloud store 710 may similarly comprise an implementation of the cloud storage 110.

Operation 712 may comprise the provider 706 authenticating its identity to the HRT 702 and requesting a set of symmetric keys for encrypting a patient health record document. This authentication may, for example, be carried out in accordance with ICard protocol. Assuming the identity of the provider 706 is properly verified by the HRT 702, operation 714 may comprise the HRT 702 generating a set of one or more symmetric keys in response to the request. In some embodiments, a single set of symmetric keys may be generated, which may serve as both encryption keys and decryption keys. Alternatively, in other embodiments, two sets of symmetric keys may be generated—the first set being for the purpose of encryption and the second set comprising the corresponding set of decryption keys. Accordingly, it will be appreciated that where symmetric keys are referred to as being requested and received for purposes of decrypting a patient health record document by a service provider entity, such as the payor 704, a service provider apparatus 104, or the like, the symmetric keys may comprise dedicated decryption keys, or may comprise the same symmetric as may have been used for both encryption of the patient health record document. The HRT 702 may further hold the generated set of symmetric keys in escrow. In some example embodiments, the set of symmetric keys may include a plurality of keys, with each corresponding to a different section of patient health information, such as in accordance with a defined standard ontology. For example, a symmetric key may be generated for each of a demographic section, clinical section, financial section, cohort section, and/or the like. In such embodiments, the HRT 702 may further create and store a key map mapping the generated set of symmetric keys to the respective sections. The provider 706 may additionally indicate to the HRT 702 (e.g., in the request for symmetric keys) the resource identifier by which the patient health record document may be accessed when published. The HRT 702 may use this resource identifier to index the escrowed keys and/or to generate a key map associating the symmetric keys with respective sections of the patient health record document.

Operation 716 may comprise the HRT 702 sending the generated set of symmetric keys for encrypting the patient health record document to the provider 706. In some embodiments, the sent set of symmetric keys may be encrypted with a public key certificate of the provider 706. In such embodiments, the provider 706 may use its private key to decrypt the encrypted set of symmetric keys. Operation 718 may comprise the provider 706 using the received set of one or more symmetric keys to encrypt the patient health record document, which may be populated with demographic, clinical, financial, and/or other aspects of the patient's visit to the provider 604. In embodiments wherein the document comprises a plurality of sections with each being associated with a different respective symmetric key, the provider 706 may encrypt each section with its respective corresponding symmetric key. This encryption may, for example, be performed using XML encryption techniques. The provider 706 may additionally sign the document, such as through use of an XML signature, to guarantee authenticity, integrity, and/or non-repudiation of the document. Operation 718 may additionally comprise the provider 706 causing the document to be published as the encounter medical record 719 in the cloud storage 710. The encounter medical record 719 may have a URL or other resource identifier enabling the document to be accessed (e.g., over a public domain network) by other entities, such as the payor 704 and the guarantor 708.

Operation 720 may comprise the provider 706 notifying the payor 704 of a claim related to the encounter medical record 719. The notification may include sufficient information for the payor 704 to identify and access the encounter medical record 719. In this regard, the notification may include the resource identifier for the encounter medical record 719 to enable the payor 704 to access the encounter medical record 719, as operation 722. The notification may also include a key map mapping respective symmetric keys to respective sections of the encounter medical record 719. The notification may additionally include an indication of the HRT 702 and/or other information enabling the payor 704 to authenticate to the HRT 702 with an existing key request related to the symmetric key(s) corresponding to the encounter medical record 719. The notification may also include authentication information enabling the payor 704 to authenticate the identity of the provider 706. This authentication information may, for example, comprise information sufficient to authenticate the provider 706 in accordance with ICard protocol.

Operation 724 may comprise the payor 704 authenticating its identity to the HRT 702. The payor 704 may additionally request a set of symmetric keys for decrypting the encounter medical record 719, as well as a new set of symmetric keys for encrypting an explanation of benefits that may be generated in response to the claim. This authentication may, for example, be carried out in accordance with ICard protocol. Assuming the identity of the payor 704 is properly verified by the HRT 702, operation 726, may comprise the HRT 702 determining a subset of the symmetric keys for decrypting the encounter medical record 719 corresponding to the section(s) of the encounter medical record 719 that the payor 704 has permission to access. This determination may, for example, be made based at least in part on patient privacy settings, such as may be made by a patient portal that may be provided by the HRT 702, and/or on a key map mapping the decryption keys to respective sections of the encounter medical record 719. Operation 726 may further comprise the HRT 702 generating a set of one or more symmetric keys for use in encrypting the explanation of benefits in response to the payor's request. As discussed with respect to operation 714, in some embodiments, a single set of symmetric keys may be generated, which may serve as both encryption keys and decryption keys. Alternatively, in other embodiments, two sets of symmetric keys may be generated—the first set being for the purpose of encryption and the second set comprising the corresponding set of decryption keys. The HRT 702 may further hold the generated set of symmetric keys in escrow. In some example embodiments, the set of one or more symmetric keys may include a plurality of keys, with each corresponding to a different section of information in the explanation of benefits document, such as in accordance with a defined standard ontology. In such embodiments, the HRT 702 may further create and store a key map mapping the generated set of keys to the respective sections.

Operation 728 may comprise the HRT 702 sending the symmetric key(s) for decrypting the encounter medical record 719 (e.g., the key(s) corresponding to the sections of the encounter medical record 719 which the payor 704 is permitted to view) and the generated set of symmetric keys for encrypting the explanation of benefits to the payor 704. In some embodiments, the keys sent to the payor 704 may be encrypted with a public key certificate of the payor 704. In such embodiments, the payor 704 may use its private key to decrypt the encrypted keys. The payor 704 may use the received symmetric key(s) for decrypting the encounter medical record 719 to decrypt the encounter medical record 719, or at least the section(s) of the encounter medical record 719 which the payor 704 is permitted to access. In embodiments wherein the payor 704 receives symmetric key(s) corresponding to respective portions of the encounter medical record 719, the payor 704 may use a key map mapping the symmetric key(s) to respective portions of the encounter medical record 719 to facilitate decryption. The payor 704 may receive the key map from the HRT 702 and/or from the provider 706. In some example embodiments wherein a single set of symmetric keys is used for both decryption and encryption, the payor 704 may receive the key map from the provider 706. For example, the key map may be included in a notification from the provider 706 informing the payor 704 of publishing of the encounter medical record 719. The key map may, for example, be encrypted using a security token generated attendant to an ICard authentication of the provider 706 to the payor 704. Alternatively, in some example embodiments wherein a first set of symmetric keys is used for encryption and a corresponding second set of symmetric keys is used for decryption, the payor 704 may obtain the key map from the HRT 702. The payor 704 may process the claim and may generate an explanation of benefits in response to the claim.

Operation 730 may comprise the payor 704 using the received set of one or more symmetric keys for encrypting the explanation of benefits to encrypt the explanation of benefits. In some embodiments, the explanation of benefits may comprise a plurality of sections (e.g., in accordance with a standardized ontology) with each being associated with a different respective symmetric key. In such embodiments, the payor 704 may encrypt each section with its respective corresponding symmetric key. This encryption may, for example, be performed using XML encryption techniques. The payor 704 may additionally sign the document, such as through use of an XML signature, to guarantee authenticity, integrity, and/or non-repudiation of the document. Operation 730 may additionally comprise the payor 704 causing the explanation of benefits to be published as the explanation of benefits 731 in the cloud storage 710. The explanation of benefits 731 may have a URL or other resource identifier enabling the document to be accessed (e.g., over a public domain network) by other entities, such as the provider 706 and the guarantor 708.

Operation 732 may comprise the payor 704 providing the provider 706 with reimbursement for the share of the charges for the patient's medical encounter which the payor 704 has agreed to pay. The reimbursement may include a routing number, account number, transaction number, security code, reimbursement amount, and/or other reimbursement information to facilitate the reimbursement transaction. This reimbursement information may, for example, be encrypted using an ICard authentication security token. The payor 704 may additionally provide sufficient information for the provider 706 to access the explanation of benefits 731. This information may, for example, include the resource identifier of the explanation of benefits 731, information enabling retrieval of symmetric key(s) for decrypting the explanation of benefits 731 from the HRT 702, a key map for mapping respective symmetric keys to respective sections of the explanation of benefits 731, and/or the like. The payor 704 may further authenticate its identity to the provider 706. In this regard, the payor 704 may provide sufficient information to the provider 706 to authenticate the payor's identity, such as in accordance with ICard protocol.

Operation 734 may comprise the provider 706 updating the patient's account balance based on the payment from the payor 704. In this regard, the provider 706 may generate and/or update account balance documentation reflecting the payment from the payor 704. Operation 734 may comprise the provider 706 encrypting the account balance document, such as with a set of one or more symmetric keys obtained from the HRT 702. This encryption may, for example, be performed using XML encryption techniques. The provider 706 may additionally sign the account balance document, such as by way of an XML signature. Operation 734 may additionally comprise the provider 706 causing the account balance document to be published as the account balance 735 in the cloud storage 710. The account balance 735 may have a URL or other resource identifier enabling the document to be accessed (e.g., over a public domain network) by other entities, such as the guarantor 708.

Operation 736 may comprise the provider 706 informing the guarantor 708 of the outstanding account balance for the patient's medical encounter (e.g., the balance remaining after the reimbursement from the payor 704 at operation 732). In this regard, the provider 706 may inform the guarantor 708 directly of the outstanding account balance and/or may provide the guarantor 708 with the resource identifier and/or other information needed for the guarantor 708 to access the account balance document 735. The provider 706 may additionally authenticate its identity to the guarantor 708. In this regard, the provider 706 may provide sufficient information to the guarantor 708 to enable the guarantor 708 to authenticate the provider's identity, such as in accordance with ICard protocol.

Operation 738 may comprise the guarantor 708 authenticating its identity to the HRT 702 and requesting symmetric keys needed for decrypting the encounter medical record 719, explanation of benefits 731, and/or account balance 735. Assuming the guarantor's identity is properly verified by the HRT 702, the HRT 702 may provide the guarantor 708 with the requested symmetric keys (e.g., the key(s) corresponding to the section(s) of the documents which the guarantor 708 is permitted to access). The guarantor 708 may use the obtained symmetric key(s) decrypt at least a portion of the encounter medical record 719, explanation of benefits 731, and/or account balance 735 and may review the records, at operation 740. In some example embodiments, operation 740 may comprise the guarantor 708 viewing the documents through a patient and guarantor portal that may be provided by the HRT 702. In this regard, the guarantor may be permitted through its relationship with the patient to review the patient's records via the portal. Accordingly, the HRT 702 may, for example, be configured to decrypt patient health record documents, or portions thereof, for viewing within the portal. Operation 742 may comprise the guarantor 708 remitting payment to the provider 706 for at least a portion of the outstanding account balance. In remitting payment, the guarantor 708 may additionally authenticate its identity to the provider 706. In this regard, the guarantor 708 may provide sufficient information to the provider 706 to enable the provider 706 to authenticate the guarantor's identity, such as in accordance with ICard protocol.

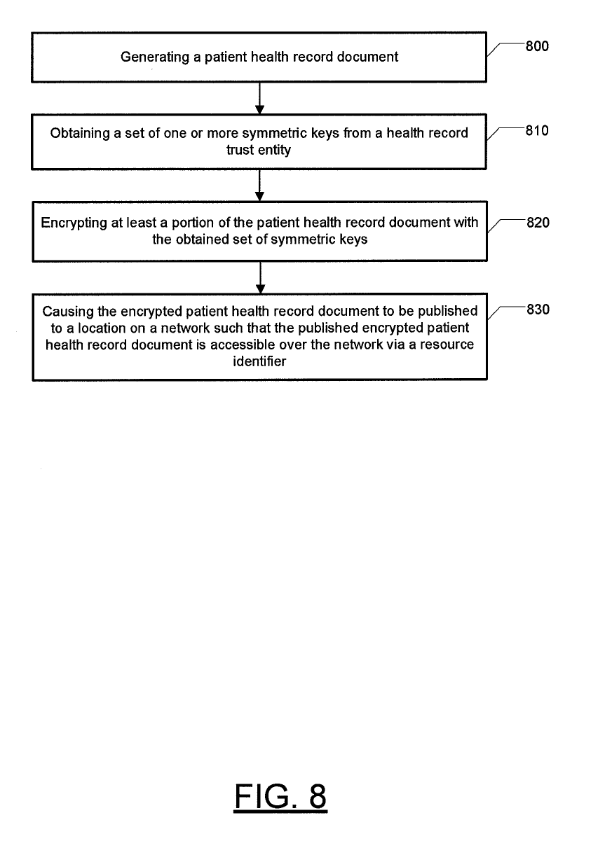

FIG. 8 illustrates a flowchart according to an example method for providing a network-accessible patient health record document according to some example embodiments. In this regard, FIG. 8 illustrates a method that may be performed at a service provider apparatus 104. The operations illustrated in and described with respect to FIG. 8 may, for example, be performed by, with the assistance of, and/or under the control of one or more of the processor 310, memory 312, communication interface 314, user interface 316, or session health record interaction unit 318. Operation 800 may comprise generating a patient health record document. The processor 310, memory 312, user interface 316, and/or session health record interaction unit 318 may, for example, provide means for performing operation 800. Operation 810 may comprise obtaining a set of one or more symmetric keys from a health record trust entity. The processor 310, memory 312, communication interface 314, user interface 316, and/or session health record interaction unit 318 may, for example, provide means for performing operation 810. It will be appreciated that the order of performance of operations 800 and 810 is not limited to that illustrated in FIG. 8, as the symmetric keys may be obtained prior to generation of the patient health record document. Operation 820 may comprise encrypting at least a portion of the patient health record document with the obtained set of symmetric keys. The processor 310, memory 312, and/or session health record interaction unit 318 may, for example, provide means for performing operation 820. Operation 830 may comprise causing the encrypted patient health record document to be published to a location on a network such that the published encrypted patient health record document is accessible over the network via a resource identifier. The processor 310, memory 312, communication interface 314, user interface 316, and/or session health record interaction unit 318 may, for example, provide means for performing operation 830.

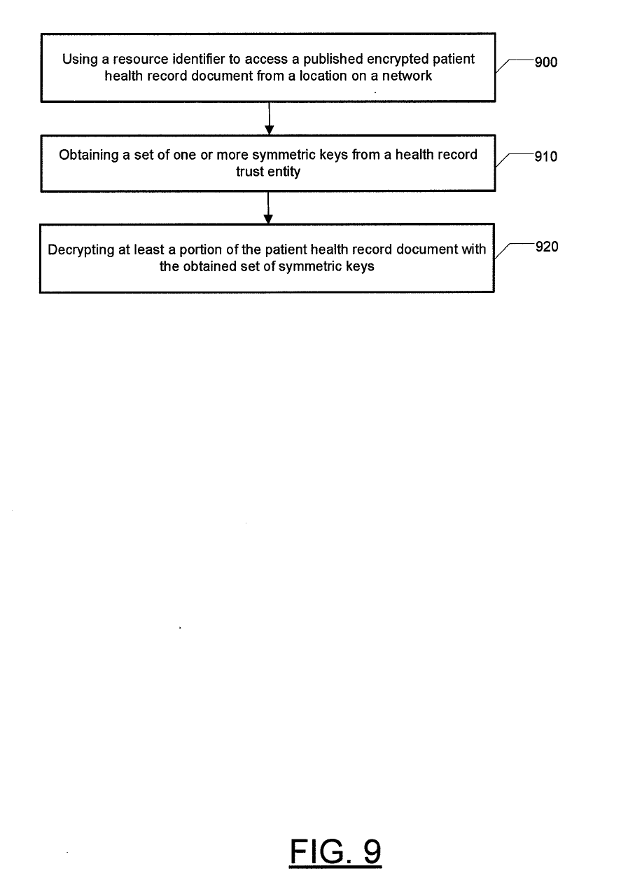

FIG. 9 illustrates a flowchart according to an example method for accessing a network-accessible patient health record document according to some example embodiments. In this regard, FIG. 9 illustrates a method that may be performed at a service provider apparatus 104. The operations illustrated in and described with respect to FIG. 9 may, for example, be performed by, with the assistance of, and/or under the control of one or more of the processor 310, memory 312, communication interface 314, user interface 316, or session health record interaction unit 318. Operation 900 may comprise using a resource identifier to access a published encrypted patient health record document from a location on a network. Operation 900 may, for example, comprise a first service provider accessing a published encrypted patient health record document that was published by a second service provider. Alternatively, operation 900 may comprise a service provider accessing a published encrypted patient health record document that was previously published by the service provider, such as for the purpose of updating patient health information included in the patient health record document. The processor 310, memory 312, communication interface 314, user interface 316, and/or session health record interaction unit 318 may, for example, provide means for performing operation 900. Operation 910 may comprise obtaining a set of one or more symmetric keys from a health record trust entity. The set of symmetric keys may be held in escrow by the health record trust entity. In some embodiments, the set of symmetric keys might comprise the same set of keys as was used to encrypt the patient health record document. In other embodiments, the set of symmetric keys for decrypting the patient health record document might correspond to a distinct set of symmetric keys used to encrypt the patient health record document. The processor 310, memory 312, communication interface 314, and/or session health record interaction unit 318 may, for example, provide means for performing operation 910. It will be appreciated that the order of performance of operations 900 and 910 is not limited to that illustrated in FIG. 9, as the symmetric keys may be obtained prior to accessing the patient health record document. Operation 920 may comprise decrypting at least a portion of the patient health record document with the obtained set of symmetric keys.

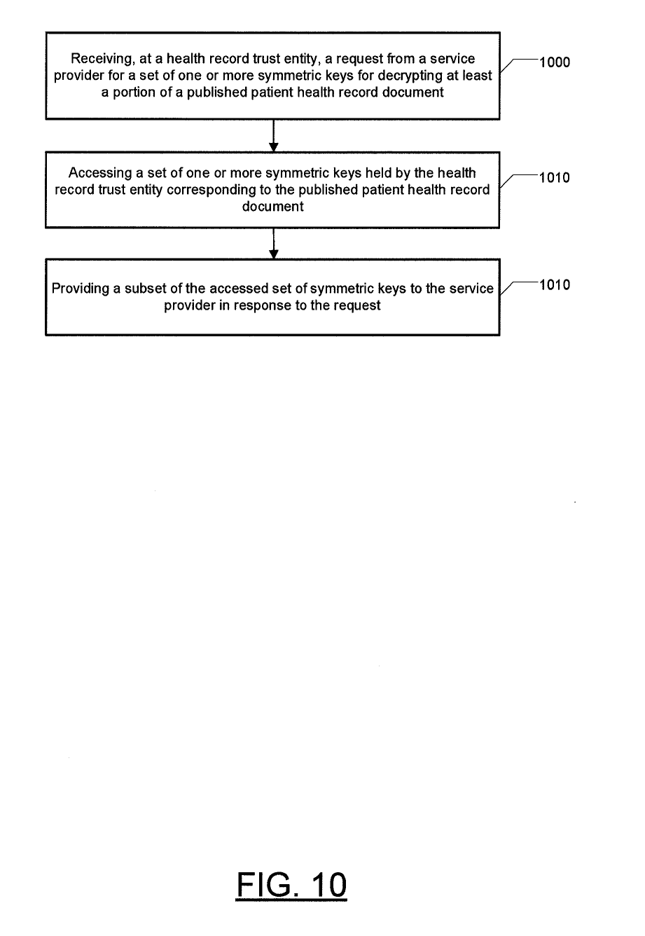

FIG. 10 illustrates a flowchart according to an example method for facilitating accessing a network-accessible patient health record document according to some example embodiments. In this regard, FIG. 10 illustrates operations that may be performed at a health record trust apparatus 102. The operations illustrated in and described with respect to FIG. 10 may, for example, be performed by, with the assistance of, and/or under the control of one or more of the processor 210, memory 212, communication interface 214, or record security controller 218. Operation 1000 may comprise receiving, at a health record trust entity, a request from a service provider for a set of one or more symmetric keys for decrypting at least a portion of a published patient health record document. The processor 210, memory 212, communication interface 214, and/or record security controller 218 may, for example, provide means for performing operation 1000. Operation 1010 may comprise accessing a set of one or more symmetric keys held by the health record trust entity corresponding to the published patient health record document. The processor 210, memory 212 and/or record security controller 218 may, for example, provide means for performing operation 1010. Operation 1020 may comprise providing a subset of the accessed set of symmetric keys to the service provider in response to the request. The processor 210, memory 212, communication interface 214, and/or record security controller 218 may, for example, provide means for performing operation 1020.

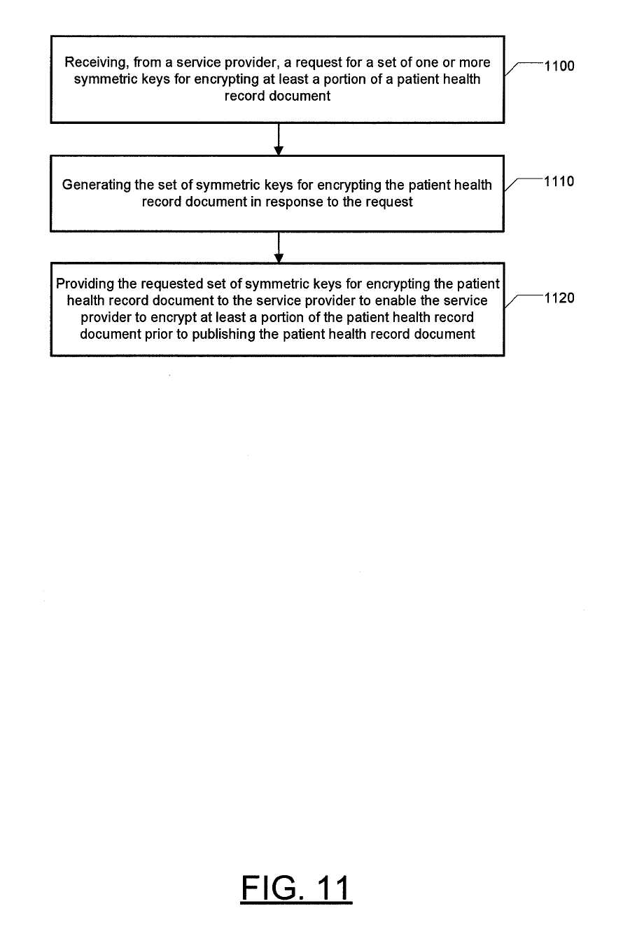

FIG. 11 illustrates a flowchart according to a further example method for facilitating accessing a network-accessible patient health record document according to some example embodiments. In this regard, FIG. 10 illustrates operations that may be performed at a health record trust apparatus 102. The operations illustrated in and described with respect to FIG. 10 may, for example, be performed by, with the assistance of, and/or under the control of one or more of the processor 210, memory 212, communication interface 214, or record security controller 218. Operation 1100 may comprise receiving, from a service provider, a request for a set of one or more symmetric keys for encrypting at least a portion of a patient health record document. The processor 210, memory 212, communication interface 214, and/or record security controller 218 may, for example, provide means for performing operation 1100. Operation 1110 may comprise generating the set of symmetric keys for encrypting the patient health record document in response to the request. The processor 210, memory 212, and/or record security controller 218 may, for example, provide means for performing operation 1110. Operation 1120 may comprise providing the requested set of symmetric keys for encrypting the patient health record document to the service provider to enable the service provider to encrypt at least a portion of the patient health record document prior to publishing the patient health record document. The processor 210, memory 212, communication interface 214, and/or record security controller 218 may, for example, provide means for performing operation 1120.

FIGS. 8-11 each illustrate a flowchart of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., an HRT apparatus 102, service provider apparatus 104, some combination thereof, and/or the like) and executed by a processor (e.g., the processor 210 and/or processor 310) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing network-accessible patient health records, the method comprising:
receiving, at a health record trust entity, a request from a service provider for a set of one or more symmetric keys for decrypting at least a portion of a published patient health record document;
accessing, by a processor, a set of one or more symmetric keys held by the health record trust entity corresponding to the published patient health record document; and
providing a subset of the accessed set of symmetric keys to the service provider in response to the request.

2. The method of claim 1, further comprising:
determining an identity of the service provider;
determining access permissions for patient health records granted to the service provider; and
determining the subset of the accessed set of symmetric keys based at least in part on the determined access permissions.

3. The method of claim 1, further comprising:
encrypting the subset of the accessed set of symmetric keys with a public-key certificate of the service provider; and
wherein providing the subset of the accessed set of symmetric keys to the service provider comprises providing the encrypted subset of the accessed set of symmetric keys to the service provider.

4. The method of claim 1, wherein the patient health record document comprises a plurality of sections, and wherein the accessed set of one or more symmetric keys includes a symmetric key corresponding to each respective section of the patient health record document.

5. The method of claim 4, further comprising:
determining the subset of the accessed set of symmetric keys based at least in part on a key map mapping the accessed set of symmetric keys to corresponding sections of the patient health record document.

6. The method of claim 1, wherein the published patient health record document is accessible over a network using a resource identifier.

7. The method of claim 1, further comprising, prior to receiving the request for the set of symmetric keys:
receiving, from a second service provider, a request for a set of one or more symmetric keys for encrypting at least a portion of the patient health record document, the second service provider being the publisher of the patient health record document;
in response to the request, generating the set of symmetric keys for encrypting the patient health record document; and
providing the requested set of symmetric keys for encrypting the patient health record document to the second service provider to enable the second service provider to encrypt at least a portion of the patient health record document prior to publishing the patient health record document.

8. The method of claim 7, wherein the patient health record document comprises a plurality of sections, and wherein generating the set of symmetric keys for encrypting the patient health record document comprises generating a symmetric key corresponding to each respective section of the plurality of sections, the method further comprising:
generating a key map mapping the generated set of symmetric keys to respective corresponding sections of the patient health record document; and
storing the generated key map to facilitate responding to a request for symmetric keys for decrypting the patient health record document.

9. The method of claim 7, wherein the symmetric keys for encrypting at least a portion of the patient health record document are the same as the accessed set of symmetric keys for decrypting at least a portion of the patient health record document.

10. The method of claim 7, wherein the symmetric keys for encrypting at least a portion of the patient health record document are different from, but correspond to the accessed set of symmetric keys for decrypting at least a portion of the patient health record document.

11. The method of claim 1, further comprising:
providing a patient portal enabling a patient to define access permissions for patient health record documents associated with the patient; and
wherein providing the subset of the accessed set of symmetric keys to the service provider in response to the request comprises providing a subset of the accessed set of symmetric keys determined based at least in part upon access permissions defined for the service provider via the patient portal.

12. An apparatus for providing network-accessible patient health records, the apparatus comprising at least one processor, wherein the at least one processor is configured to cause the apparatus to at least:
receive, at a health record trust entity, a request from a service provider for a set of one or more symmetric keys for decrypting at least a portion of a published patient health record document;
access a set of one or more symmetric keys held by the health record trust entity corresponding to the published patient health record document; and
provide a subset of the accessed set of symmetric keys to the service provider in response to the request.

13. The apparatus of claim 12, wherein the at least one processor is configured to further cause the apparatus to:
determine an identity of the service provider;
determine access permissions for patient health records granted to the service provider; and
determine the subset of the accessed set of symmetric keys based at least in part on the determined access permissions.

14. The apparatus of claim 12, wherein the at least one processor is configured to further cause the apparatus to:
encrypt the subset of the accessed set of symmetric keys with a public-key certificate of the service provider; and
provide the subset of the accessed set of symmetric keys to the service provider by providing the encrypted subset of the accessed set of symmetric keys to the service provider.

15. The apparatus of claim 12, wherein the patient health record document comprises a plurality of sections, and wherein the accessed set of one or more symmetric keys includes a symmetric key corresponding to each respective section of the patient health record document.

16. The apparatus of claim 15, wherein the at least one processor is configured to further cause the apparatus to:
determine the subset of the accessed set of symmetric keys based at least in part on a key map mapping the accessed set of symmetric keys to corresponding sections of the patient health record document.

17. The apparatus of claim 12, wherein the published patient health record document is accessible over a network using a resource identifier.

18. The apparatus of claim 12, wherein the at least one processor is configured to further cause the apparatus, prior to receiving the request for the set of symmetric keys, to:
receive, from a second service provider a request for a set of one or more symmetric keys for encrypting at least a portion of the patient health record document, the second service provider being the publisher of the patient health record document;
generate the set of symmetric keys for encrypting at least a portion of the patient health record document in response to the received request; and
provide the requested set of symmetric keys for encrypting at least a portion of the patient health record document to the second service provider to enable the second service provider to encrypt at least a portion of the patient health record document prior to publishing the patient health record document.

19. The apparatus of claim 18, wherein the at least one processor is configured to further cause the apparatus to:
generate a key map mapping the generated set of symmetric keys to respective corresponding sections of the patient health record document; and
store the generated key map to facilitate responding to a request for symmetric keys for decrypting the patient health record document

20. The apparatus of claim 12, further comprising at least one memory storing instructions that when executed by the at least one processor cause the apparatus to:
receive, at the health record trust entity, the request from the service provider for the set of one or more symmetric keys for decrypting at least a portion of a published patient health record document;
access the set of one or more symmetric keys held by the health record trust entity corresponding to the published patient health record document; and
provide the subset of the accessed set of symmetric keys to the service provider in response to the request.

21. A computer program product for providing network-accessible patient health records, the computer program product comprising at least one non-transitory computer-readable storage medium having computer-readable program instructions stored therein, the computer-readable program instructions comprising:
program instructions configured to receive, at a health record trust entity, a request from a service provider for a set of one or more symmetric keys for decrypting at least a portion of a published patient health record document;
program instructions configured to access a set of one or more symmetric keys held by the health record trust entity corresponding to the published patient health record document; and
program instructions configured to provide a subset of the accessed set of symmetric keys to the service provider in response to the request.

22. A method for providing network-accessible patient health records, the method comprising:
using a resource identifier to access a published encrypted patient health record document from a location on a network;
obtaining a set of one or more symmetric keys from a health record trust entity, the set of symmetric keys being held by the health record trust entity; and
decrypting, by a processor, at least a portion of the patient health record document with the obtained set of symmetric keys.

23. The method of claim 22, wherein obtaining the set of one or more symmetric keys from the health record trust entity comprises:
authenticating an identity of a service provider to the health record trust entity;
receiving an encrypted set of one or more symmetric keys from the health record trust entity, the encrypted set of symmetric keys being encrypted based on a public-key certificate of the service provider; and
using a private key of the service provider to decrypt the received encrypted set of symmetric keys.

24. The method of claim 22, wherein the published encrypted patient health record comprises a plurality of encrypted sections, each encrypted section corresponding to a different symmetric key, and wherein:
obtaining the set of one or more symmetric keys comprises obtaining a set of one or more symmetric keys corresponding to a subset of the plurality of encrypted sections which a service provider requesting the symmetric keys from the health record trust entity has permission to access; and
decrypting at least a portion of the patient health record document comprises decrypting one or more encrypted sections of the patient health record document corresponding to the obtained set of symmetric keys.

25. The method of claim 24, wherein decrypting one or more encrypted sections of the patient health record document comprises decrypting one or more encrypted sections of the patient health record document corresponding to the obtained set of symmetric keys based on a key map mapping the obtained symmetric keys to respective sections of the patient health record document, the key map being received from one of the health record trust entity or a second service provider.

26. The method of claim 22, wherein access to the location from which the encrypted patient health record is accessed is not controlled by the health record trust entity.

27. The method of claim 22, further comprising:
receiving notification of publication of the encrypted patient health record; and
wherein using a resource identifier to access the published encrypted patient health comprises accessing the published encrypted patient health record responsive to the received notification.

28. The method of claim 22, further comprising:
generating a patient health record document;
obtaining a set of one or more symmetric keys for encrypting the generated patient health record document from the health record trust entity;
encrypting at least a portion of the generated patient health record document with the obtained set of symmetric keys for encrypting the generated patient health record document; and
causing the encrypted generated patient health record document to be published to a location on a network, the published encrypted generated patient health record document having a resource identifier enabling the published encrypted generated patient health record document to be accessed over the network.

29. The method of claim 28, wherein a set of one or more symmetric keys configured to decrypt the encrypted generated patient health record document are held by the health record trust entity.

30. The method of claim 28, wherein:
generating the patient health record document comprises generating a patient health record document comprising a plurality of sections;
obtaining the set of one or more symmetric keys for encrypting comprises obtaining a set of symmetric keys for encrypting including a symmetric key corresponding to each respective section of the generated patient health record document; and
encrypting at least a portion of the generated patient health record document comprises encrypting each section of the generated patient health record with its corresponding obtained symmetric key for encrypting.
